(19) United States
(12) Patent Application Publication
(10) Pub. No.: US 2024/0047744 A1
(43) Pub. Date: Feb. 8, 2024

(54) COMPOSITE SOLID ELECTROLYTES FOR LITHIUM BATTERIES

(71) Applicant: University of Utah Research Foundation, Salt Lake City, UT (US)

(72) Inventors: Xuming WANG, Salt Lake City, UT (US); Jan Dean MILLER, Salt Lake City, UT (US); Patrick MULLER, Salt Lake City, UT (US)

(21) Appl. No.: 18/322,420

(22) Filed: May 23, 2023

Related U.S. Application Data
(60) Provisional application No. 63/344,761, filed on May 23, 2022.

(51) Int. Cl. H01M 10/0565; H01M 10/0568

(52) U.S. Cl. CPC H01M 10/0565; H01M 10/0568

(57) ABSTRACT

A composite solid electrolyte for lithium batteries can include a solid polymer, phyllosilicate nanoparticles distributed in the solid polymer, a lithium salt distributed in the solid polymer, and a plasticizer distributed in the solid polymer. The composite solid electrolyte can be used in a solid-state lithium battery cell made up of a composite solid electrolyte, an anode containing lithium in contact with a first surface of the composite solid electrolyte, and a cathode in contact with a second surface of the composite solid electrolyte.

### CROSS REFERENCE TO RELATED APPLICATION

This application claims priority to U.S. Provisional Application No. 63/344,761, filed May 23, 2022, which is incorporated herein by reference.

### STATEMENT REGARDING FEDERALLY SPONSORED RESEARCH OR DEVELOPMENT

This invention was made with government support under grant 80NSSC21C0027 awarded by the National Aeronautics and Space Administration. The government has certain rights in this invention.

### NAMES OF THE PARTIES TO A JOINT RESEARCH AGREEMENT

Not applicable.

### INCORPORATION BY REFERENCE STATEMENT

Not applicable.

### BACKGROUND

Lithium ion (Li-ion) battery technology has been applied in portable electronic devices for many years. More recently, Li-ion batteries have been used in transportation systems such as hybrid and electric vehicles. These markets present different challenges in battery cell design, the former requiring generally higher power density, and the latter requiring higher energy density for greater degrees of vehicle electrification. However, the need for improved conductivity and diffusivity are common to both markets. Conventional liquid or gel electrolytes can provide satisfactory performance. Liquid and gel electrolytes can also provide good contact with electrodes and accommodate volume changes in the electrodes during charging and discharging of the battery. However, solvent leakage and flammability of conventional liquid electrolytes create safety and reliability concerns.

The use of a solid polymer electrolyte instead of the conventional liquid or gel electrolyte can significantly improve the safety aspects of a Li-ion battery. However, PEO-based (polyethylene oxide-based) solid electrolytes often do not meet functional performance requirements. For example, at low temperatures, the conductivity of solid electrolytes can be poor due to the presence of crystalline PEO segments, which restricts the lithium ion mobility. This limits the useful operating temperature of Li-ion polymer batteries employing such solid electrolytes to between 70° C. and 100° C., which excludes the use of solid polymer-based batteries in room temperature applications. Therefore, improvements to Li-ion battery performance continues to be sought.

### SUMMARY

A composite solid electrolyte for lithium batteries can include a solid polymer, phyllosilicate nanoparticles distributed in the solid polymer, a lithium salt distributed in the solid polymer, and a plasticizer distributed in the solid polymer. The combination of phyllosilicate nanoparticles and plasticizer distributed in the solid polymer can increase lithium ion transfer through the composite solid electrolyte.

A solid-state lithium battery cell can be formed from a composite solid electrolyte layer, an anode in contact with a first surface of the composite solid electrolyte layer, and a cathode in contact with a second surface of the composite solid electrolyte layer. The composite solid electrolyte layer can include a solid polymer, phyllosilicate nanoparticles distributed in the solid polymer, a lithium salt distributed in the solid polymer, and a plasticizer distributed in the solid polymer. The anode can contain lithium. A casing can enclose the solid-state battery cell and exclude oxygen from the solid-state battery cell.

Additional features and advantages of these principles will be apparent from the following detailed description, which illustrates, by way of example, features of the invention.

### BRIEF DESCRIPTION OF THE DRAWINGS

FIG. 1 is a schematic of a composite solid electrolyte in accordance with an example of the present technology.

FIG. 2 shows an example chemical mechanism of forming a composite solid electrolyte in accordance with an example of the present technology.

FIG. 3 shows another example chemical mechanism of forming a composite solid electrolyte in accordance with an example of the present technology.

FIG. 4 is a schematic of a solid-state lithium battery cell in accordance with an example of the present technology.

FIG. 5A is a perspective view of a coin cell solid-state lithium battery in accordance with an example of the present technology.

FIG. 5B is an exploded view of a coin cell solid-state lithium battery in accordance with an example of the present technology.

FIG. 6 is a graph of cycling data for a lithium/sulfur battery using the new electrolyte formulation given in Table 1.

FIG. 7 is a graph of comparison of cycling for lithium/sulfur battery performance.

FIG. 8 is a graph of GN variable line fit plot of conductivity.

FIG. 9 is a graph of PEG (P2) variable line fit plot of conductivity.

FIG. 10 is a graph of GN/PEG (P2) interaction viable line fit plot of conductivity.

FIG. 11 is a graph of transmittance vs. equilibration time for various types of raw and modified halloysite nanotubes dispersed in water.

FIG. 12 is a graph of log conductivity vs. 1000/T (K) for composite solid electrolytes made with raw and modified halloysite nanotubes.

FIG. 13 is a group of Nyquist plots recorded using electrochemical impedance spectroscopy for several different composite solid electrolytes.

It should be noted that the figures are merely exemplary of several embodiments and no limitations on the scope of the present invention are intended thereby. Further, the figures are generally not drawn to scale, but are drafted for purposes of convenience and clarity in illustrating various aspects of the invention.

### DETAILED DESCRIPTION

Reference will now be made to exemplary embodiments and specific language will be used herein to describe the same. It will nevertheless be understood that no limitation of the scope of the invention is thereby intended. Alterations and further modifications of the inventive features described herein, and additional applications of the principles of the invention as described herein, which would occur to one skilled in the relevant art and having possession of this disclosure, are to be considered within the scope of the invention. Further, before particular embodiments are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

### Definitions

In describing and claiming the present invention, the following terminology will be used.

The singular forms “a,” “an,” and “the” include plural references unless the context clearly dictates otherwise. Thus, for example, reference to “a nanoparticle” includes reference to one or more of such structures, “a salt” includes reference to one or more of such materials, and “a mixing step” refers to one or more of such steps.

As used herein, “plasticizer” is defined as a substance that, when added to the solid polymer in the composite solid electrolytes described herein, increases the plasticity of the solid polymer. Increasing the plasticity can include increasing flexibility, workability, and/or stretchability. In some cases, increasing plasticity of a polymer can include reducing the Shore A hardness of the polymer.

As used herein, “bilayer phyllosilicate” refers to a phyllosilicate material having a crystal structure with a positively charged surface on one face and a negatively charged surface on an opposite face. In some cases, bilayer phyllosilicates can form flat sheets with oppositely charged top and bottom faces, or nanotubes with oppositely charged interior and exterior surfaces. Phyllosilicates in general are silicate minerals containing silicate tetrahedrons arranged in sheets. Non-limiting examples of phyllosilicates include halloysite, kaolinite, chrysotile, antigorite, talc, pyrophyllite, montmorillonite, chlorite, mica, sepiolite, serpentine, and others. In some cases, the phyllosilicates are natural unmodified nanomaterials. Bilayer phyllosilicates include halloysite, kaolinite, chrysotile, and antigorite.

As used herein, “nanoparticle” refers to a particle having a dimension in the nanoscale, such as from about 1 nm to about 1000 nm. Nanoparticles can include a variety of morphologies, such as nanospheres, nanoplatelets, nanotubes, and others.

As used herein, “lithium ion transference number” or “t⁺” is defined as follows. An electrolyte is tested in a symmetric cell with lithium anode and lithium cathode surrounding the electrolyte. When a constant polarization voltage of 10 mV is applied to the cell, a current is measured from the initial value to a steady-state value after 4 hours. AC impedance plots of the film before and after polarization are obtained. The frequency range is from 300 kHz to 10 Hz and the signal amplitude is 10 mV. The t⁺ is given by the following expression:

$${t}^{+} = \frac{{I}_{S} ( V - {I}_{0} {R}_{0} )}{{I}_{0} ( V - {I}_{S} {R}_{0} )}$$

where V is the DC voltage applied to the cell; R₀ and R_{S} are the initial and steady-state resistances of the passivating layer, respectively; and I₀ and I_{S} are the initial and steady-state current, respectively.

As used herein, “conductivity” refers to lithium ionic conductivity unless otherwise stated. Conductivity is typically given in units of siemens per centimeter (S cm⁻¹). The conductivity (σ) is:

$$σ = \frac{i}{S {R}_{b}}$$

where l is the thickness of the electrolyte, R_{b} is the resistance of the electrolyte, and S is the area of the electrodes used to test the resistance of the electrolyte. The ionic conductivity values described herein were obtained by complex plane impedance plots between 25° C. and 100° C. with an impedance analyzer. The composite solid electrolyte film was sandwiched between a stainless steel (SS) disk with diameter d=1.6 cm and the positive shell of a 2025 coin cell to form a symmetric stainless steel/electrolyte/stainless steel cell for testing.

As used herein, “substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context. Similarly, “substantially free of” or the like refers to the lack of an identified element or agent in a composition. Particularly, elements that are identified as being “substantially free of” are either completely absent from the composition, or are included only in amounts which are small enough so as to have no measurable effect on the composition.

As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussion below regarding ranges and numerical data.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a range of about 1 to about 200 should be interpreted to include not only the explicitly recited limits of 1 and 200, but also to include individual sizes such as 2, 3, 4, and sub-ranges such as 10 to 50, 20 to 100, etc.

As used herein, the term “at least one of” is intended to be synonymous with “one or more of.” For example, “at least one of” A. B and C explicitly includes only A, only B, only C, and combinations of each.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

### Composite Solid Electrolytes

The present disclosure describes composite solid electrolytes that can provide the benefits of solid polymer electrolytes w % bile also providing adequate lithium ionic conductivity to make batteries with good performance. The composite solid electrolyte can be made in the form of a flexible thin membrane. This electrolyte can be advantageously used for solid-state micro-scale lithium batteries due to the small size and weight of the electrolyte. Similar advantages can be gained by co-locating micro-scale batteries and integrated circuits on a single chip. The composite solid electrolyte can also make battery cells safer by eliminating flammable and reactive liquid electrolytes. Thus, the electrolyte can potentially be used in safe, lightweight batteries for electric vehicles. Finally, the electrolyte can have adequate lithium ionic conductivity across a wide range of temperatures, including room temperature. This allows for batteries that can be used in a variety of commercial applications.

The composite solid electrolytes described herein can include a plasticizer distributed in the solid polymer, which has been found to further increase lithium ionic conductivity. In some examples, the composite solid electrolytes can include additional ingredients that can even further increase the lithium ionic conductivity, such as multiple plasticizers and phyllosilicate nanoparticles modified with various modifying agents. Plasticizers have been found to increase the ionic conductivity of the composite solid electrolyte compared to similar composite solid electrolytes that do not include a plasticizer. Without being bound to a particular mechanism, it is believed that the plasticizer may decrease the crystallinity of the solid polymer matrix. Since a crystalline polymer can have lower ionic conductivity, reducing the crystallinity can increase the overall ionic conductivity of the electrolyte. The ionic conductivity can be sufficiently high for use even at low temperatures. Including phyllosilicate nanoparticles with certain modifying agents has also been found to increase the ionic conductivity. These ingredients are discussed in more detail below. As an example, the plasticizer can be compatible with the polymer (e.g. PEO) in terms of solubility and molecular weight.

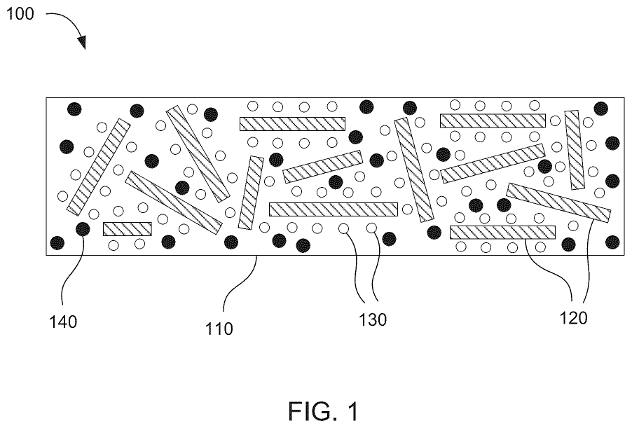

In one example of the present technology, a composite solid electrolyte can include a solid polymer, phyllosilicate nanoparticles distributed in the solid polymer, a lithium salt distributed in the solid polymer, and a plasticizer distributed in the solid polymer. FIG. 1 shows a schematic cross section (not to scale) of one example of a composite solid electrolyte 100. The composite solid electrolyte includes a matrix of a solid polymer 110 with phyllosilicate nanoparticles 120 and lithium ions 130 dispersed therein. Molecules or particles of a plasticizer 140 are also distributed in the solid polymer. This combination of materials can have good ionic conductivity at room temperature for use in a lithium ion battery.

In certain examples, the solid polymer of the composite solid electrolyte can be a polyether such as polyethylene oxide or polypropylene oxide. Additional non-limiting examples of suitable solid polymers can include polymethyl methacrylate, polycarbonate, polysiloxane, starch, sugar, fiber, polyvinyl alcohol, polyphosphazene and polystyrene. Such polymers can sometimes be used as polymeric electrolytes without the addition of the phyllosilicate nanoparticles. However, the polymers can have crystallinity at low temperatures that reduces the conductivity of the polymer at low temperatures. Thus, these polymers may be usable as electrolytes at high temperatures, such as 70° C. or higher. Without being bound to a particular mechanism, it is believed that adding phyllosilicate nanoparticles to the polymer can inhibit the crystallization of the polymer chains, which leads to increased low temperature conductivity.

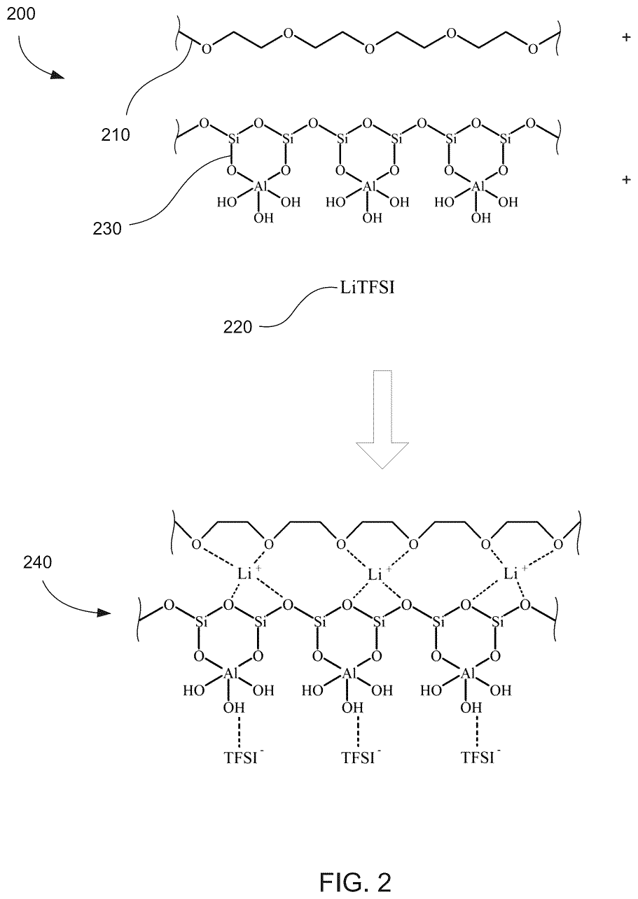

Additionally, the differing charged surfaces of the bilayer structure of the phyllosilicate can further improve low temperature and high temperature ionic conductivity over and above the crystallization inhibiting effect described above. The charge properties of bilayer phyllosilicates have surprisingly been found to provide even better low temperature and high temperature ionic conductivity compared to other inorganic particles that have been added to polymeric electrolytes. Without being bound to a specific mechanism, it is believed that specific interactions occur between surface groups of the bilayer phyllosilicate and the lithium salt and polymer. These interactions can be interpreted in terms of Lewis acid-base group interactions. One example of this mechanism 200 is shown in FIG. 2. In this example, a segment of polyethylene oxide (PEO) 210 is shown being combined with lithium bis-trifluoromethanesulfonimide (LiTFSI) 220, and a segment of a halloysite nanotube 230. Combining these materials forms the composite 240.

Further, the addition of one or more plasticizers can further disrupt crystal formation as discussed above, and can increase interfacial ion transfer. The plasticizer can also act as a dispersant to increase uniformity of distribution within the polymer, while also acting as a coupling agent to the polymer matrix. Plasticizers that may be used in the composite solid electrolyte can include solvents, small molecules (i.e., non-polymeric molecules such as compounds having a molecular weight less than about 200 g/mol), and polymeric plasticizers. If a polymeric plasticizer is used, in some examples the polymeric plasticizer can have a lower molecular weight than the solid polymer matrix of the composite solid electrolyte. For example, a ratio of the molecular weight of the polymeric plasticizer to the molecular weight of the solid polymer matrix can be from about 1:1,000 to about 1:5, or from about 1:500 to about 1:10, or from about 1:500 to about 1:50.

In certain examples, the composite solid electrolyte can include polyethylene glycol as a polymeric plasticizer. In some specific examples, the solid polymer matrix of the composite solid electrolyte can be polyethylene oxide and the plasticizer can include polyethylene glycol. On the scale of individual monomers, the structure of polyethylene oxide is the same as the structure of polyethylene glycol. Both polymers are polymers of ethylene oxide. These polymers are typically distinguished based on molecular weight, with polymers having a molecular weight over 20,000 g/mol referred to as polyethylene oxide and polymers having a molecular weight below 20,000 g/mol referred to as polyethylene glycol. Thus, the polyethylene glycol plasticizer can have a lower molecular weight than the polyethylene oxide matrix. In some examples, the solid polymer matrix of the composite solid electrolyte can include polyethylene oxide having a molecular weight from about 50,000 g/mol to about 2,000,000 g/mol, or from about 100,000 g/mol to about 1,000,000 g/mol, or from about 200,000 g/mol to about 600,000 g/mol. In further examples, the composite solid electrolyte can also include polyethylene glycol as a plasticizer, with a molecular weight from about 200 g/mol to about 10,000 g/mol, or from about 200 g/mol to about 4,000 g/mol, or from about 200 g/mol to about 400 g/mol, or from about 4,000 g/mol to about 10,000 g/mol. Polyethylene glycol can also be used as a plasticizer with other solid polymer matrix materials besides polyethylene oxide. Polyethylene glycol derivatives can also be used as plasticizers in some examples. In other examples, polypropylene glycol and polypropylene glycol derivatives in similar molecular weight ranges can also be used as plasticizers.

Other examples of plasticizers can include dinitriles. These can include malonitrile, succinonitrile, glutaronitrile, 2-methyl glutaronitrile, adiponitrile, and others. In particular examples, glutaronitrile can be used as a plasticizer.

Additional plasticizers can include a citrate, a benzoate, an ortho-phthalate, a terephthalate, an adipate, an azelate, a sebacate, a trimellitate, a polyester, and combinations thereof. Specific examples can include diethylhexyl phthalate, di-2-ethylhexyl terephthalate, diisononyl phthalate, diisodecyl phthalate, dibutyl phthalate, butyl benzyl phthalate, diisoheptyl phthalate, dihexyl phthalate, diisooctylphthalate, di-iso-undecyl phthalate, dimethyl phthalate, diisotridecyl phthalate, di-isononyl adipate, di-2-ethylhexyl adipate, di-isodecyl adipate, dioctyl adipate, bis(2-ethylhexyl adipate), polyadipate ester, acetyl tributyl citrate, tributyl citrate, triethyl citrate, acetyl (2-ethylhexyl) citrate, trioctyl citrate, tris (2-ethylhexyl) trimellitate, tri-isononyl trimellitate, trioctyl trimellitate, and combinations thereof.

The plasticizer can be included in the composite solid electrolyte in a total amount from about 4 wt % to about 50 wt % with respect to the total weight of the composite solid electrolyte. In certain examples, the total amount of plasticizer can be from about 4 wt % to about 30 wt %, or from about 4 wt % to about 20 wt %, or from about 4 wt % to about 10 wt %, or from about 10 wt % to about 50 wt %, or from about 10 wt % to about 40 wt %, or from about 10 wt % to about 30 wt %, or from about 20 wt % to about 50 wt %, or from about 20 wt % to about 40 wt %, or from about 30 wt % to about 50 wt %, or from about 30 wt % to about 40 wt %, or from about 35 wt % to about 45 wt % with respect to the total weight of the composite solid electrolyte. In certain examples, the plasticizer can include two different plasticizing compounds. In some examples, a first plasticizer can be present in an amount from about 2 wt % to about 10 wt % with respect to the total weight of the composite solid electrolyte, and a second plasticizer can be present in an amount from about 2 wt % to about 40 wt %. In further examples, the first plasticizer can be present in an amount from about 2 wt % to about 8 wt %, or from about 2 wt % to about 6 wt %, or from about 2 wt % to about 4 wt %, or from about 4 wt % to about 10 wt %, or from about 4 wt % to about 8 wt %, or from about 4 wt % to about 6 wt %, or from about 6 wt % to about 10 wt %, or from about 6 wt % to about 8 wt %, or from about 8 wt % to about 10 wt %, and the second plasticizer can be present in an amount from about 2 wt % to about 30 wt %, or from about 2 wt % to about 20 wt %, or from about 2 wt % to about 10 wt %, or from about 10 wt % to about 40 wt %, or from about 10 wt % to about 30 wt %, or from about 10 wt % to about 20 wt %, or from about 20 wt % to about 40 wt %, or from about 20 wt % to about 30 wt %, or from about 30 wt % to about 40 wt %, or from about 30 wt % to about 35 wt %, or from about 35 wt % to about 40 wt %.

In certain examples, the plasticizer can include PEG and the PEG can be included in an amount from about 2 wt % to about 10 wt %, or from about 2 wt % to about 8 wt %, or from about 2 wt % to about 6 wt %, or from about 2 wt % to about 4 wt %, or from about 4 wt % to about 10 wt %, or from about 4 wt % to about 8 wt %, or from about 4 wt % to about 6 wt %, or from about 6 wt % to about 10 wt %, or from about 6 wt % to about 8 wt %, or from about 8 wt % to about 10 wt % a.

In further examples, the plasticizer can include a dinitrile, and the dinitrile can be present in an amount from about 2 wt % to about 40 wt %, or from about 2 wt % to about 30 wt %, or from about 2 wt % to about 20 wt %, or from about 2 wt % to about 10 wt %, or from about 10 wt % to about 40 wt %, or from about 10 wt % to about 30 wt %, or from about 10 wt % to about 20 wt %, or from about 20 wt % to about 40 wt %, or from about 20 wt % to about 30 wt %, or from about 30 wt % to about 40 wt %, or from about 30 wt % to about 35 wt %, or from about 35 wt % to about 40 wt %. In a particular example, the dinitrile can be glutaronitrile.

In some cases, the plasticizer includes a combination of a polyethylene glycol (PEG) and a dinitrile. In certain examples, the plasticizer can include a dinitrile and a PEG having a molecular weight of 200 to 10.000, 200 to 400, or 4000 to 10,000. In further examples, the dinitrile can be glutaronitrile. The dinitrile can be included in an amount greater than the PEG in some examples. In more specific examples, a weight ratio of PEG to dinitrile can be from about 1:4 to about 1:20, or from about 1:4 to about 1:15, or from about 1:4 to about 1:10, or from about 1:4 to about 1:8, or from about 1:4 to about 1:6, or from about 1:5 to about 1:10, or from about 1:6 to about 1:10, or from about 1:6 to about 1:8.

In one particular aspect, the phyllosilicates can be bilayer phyllosilicates. The bilayer phyllosilicates can generally be either planar (e.g. kaolinite, antigorite, etc.) or nanotubular (e.g. halloysite, chrysotile, etc.). The halloysite nanotube has a bilayer structure with the chemical composition Al₂Si₂O₅(OH)₄. The exterior face of the nanotube contains SiO₂ and the interior face contains Al(OH)₃. These faces exhibit a difference in the sign of surface charge for certain conditions, which provide more Lewis acid-base interaction sites. Lewis acid-base sites interact with the ionic species Li⁺ and TFSI⁻, thus lowering ionic coupling. This can promote salt dissociation via a sort of “ion-halloysite-nanotube complex” formation. As shown in FIG. 2, the Li⁺ ions can complex with the exterior surface of the nanotube while the TFSI⁻ ions can complex with the interior surface. The ethylene oxide units on PEO also have an abundance of lone-pair electrons that can interact with the Li+ ions on the outer HNT surface, as the polymer becomes organized and conformed to the HNT nanoparticles. The Lewis acid-base interactions among HNT, LiTFSI, and PEO effectively order the ions into 3D channels. These interactions can significantly shorten the distance of free Li+ ion transfer, lower ionic coupling, disturb the PEO crystallinity, decrease the phase transition temperature, and provide a high-speed freeway for lithium ion transport through the composite solid electrolyte.

Halloysite nanotubes (HNTs) are based on aluminosilicate clay nanosheets that naturally occur as hollow tubular structures. This mineral can be mined from deposits in Utah in the United States as well as in other deposits around the world. The ideal unit formula for halloysite is Al₂Si₂O₅(OH)₄·nH₂O (n=0 for halloysite-(7 Å) and n=2 for hydrated halloysite-(10 Å). Unlike other nano-structured clays that must be exfoliated, HNTs naturally occur with typical dimensions of 10-50 nm for the outer diameter and 5-20 rim for the inner diameter, with a length for 50 to 1000 nm. As is the case for many clays, the halloysite structure has two components: (1) sheets of corner shared silica tetrahedra and (2) sheets of edge shared alumina octahedra. The layers building up the final structure are composed by alternating one of each of these sheets so that the crystal structure of halloysite is described as a 1:1 dioctahedral layered silicate. Compared to other nanomaterials, such as carbon nanotubes, graphene etc., the halloysite nanotubes have several advantages. For example, halloysite nanotubes are a natural nanotube material of low cost having excellent chemical and physical stability.

Other bilayer phyllosilicate nanoclays can provide similar improvement in ionic conductivity because they have similar chemical composition. For example, kaolinite is a bilayer phyllosilicate clay and has the same chemical composition (Al₂Si₂O₅(OH)₄) as that of halloysite. Kaolinite can also provide improvement in conductivity when kaolinite nanoparticles are used to synthesize the nanocomposite electrolyte.

In some examples, modification of phyllosilicates can further improve the ionic conductivity. Therefore, in addition to halloysite nanotubes, other phyllosilicate structures and modification of such structures can be used for nanocomposite electrolytes in lithium ion batteries. In various examples, the phyllosilicates can be bilayer, trilayer or mixed layer structures and include both tubular structures and flat, layered structures. In certain examples, the phyllosilicates can be either aluminum or magnesium phyllosilicates which can be modified to promote the transport of lithium ions. In one such example, the modification can include, but is not limited to, replacement of interlayer cations with lithium ions.

In a particular example, the bilayer phyllosilicate nanoparticles can be in the form of nanotubes having a polymer electrolyte impregnated in an interior volume of the nanotubes. In some cases, the polymer electrolyte can be a liquid.

In further examples, the bilayer phyllosilicate nanoparticles can be chemically modified. Non-limiting examples of modifications can include surface modification such as surface oxidation, thermal treatment (hydration, oxidation), acid/base treatment (dissolution), and surface functional group loading by reaction. For example, the phyllosilicate nanoparticles can be modified with at least one of potassium tripolyphosphate, ammonium polyacrylate, hydroxylation, and ammonia. As used herein, halloysite nanotubes modified with potassium tripolyphosphate can be referred to as “HPKT” as an abbreviation. Halloysite nanotubes modified with ammonia can be referred to as “HPA” as an abbreviation.

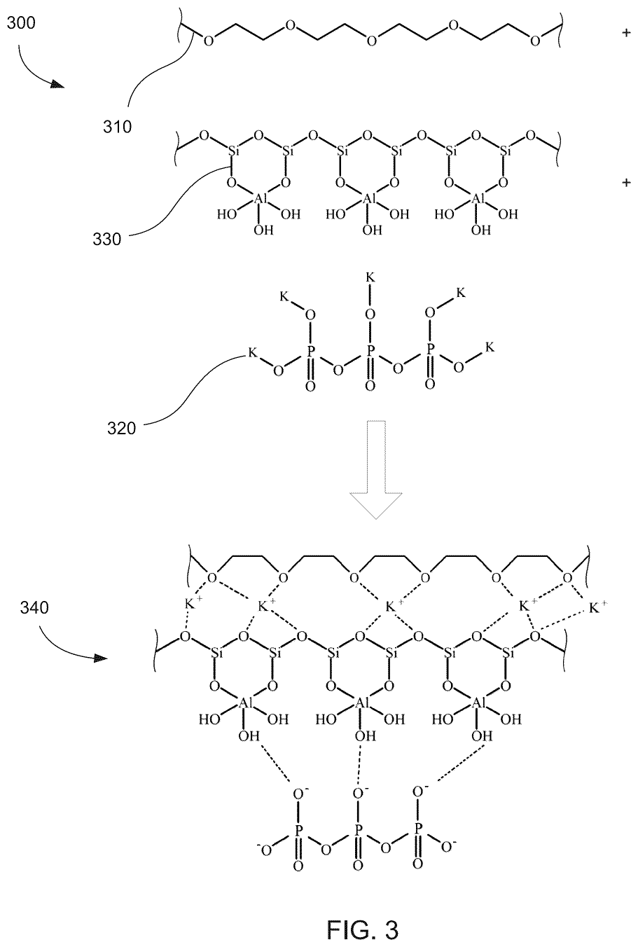

The phyllosilicate nanoparticles can be modified with surface functional groups by chemical reaction. As an example, halloysite nanotubes can be modified by adsorption reactions with controlled modifier concentration and temperature. Without being bound to a particular mechanism, in some examples a salt such as potassium tripolyphosphate can complex with the surfaces of phyllosilicate nanoparticles. In particular, potassium tripolyphosphate includes potassium cations and the tripolyphosphate anion. These ions can complex with the surfaces of halloysite nanotubes in a similar way to the Li⁺ ions and TFSI⁻ ions described above. FIG. 3 shows an example mechanism 300 for combining potassium tripolyphosphate 320 with a halloysite layer 330 and polyethylene oxide 310. When combined, the potassium ions (K′) can complex with the more negative oxygen atoms on the outer surface of the halloysite nanotube. The tripolyphosphate anion can complex with the more positive hydrogen atoms of the hydroxyls on the inner surface of the halloysite nanotube. The potassium ions can also complex with the oxygen atoms of the polyethylene oxide polymer chain. This can form a complex 340 shown in the figure. Thus, the potassium tripolyphosphate can help to couple the halloysite nanotubes with the polymer, which can increase the quality of the film. Modifying halloysite nanotubes with potassium tripolyphosphate can also increase the dispersibility of the halloysite nanotubes in water, which can provide for a more uniform and stable dispersion when preparing the electrolyte film.

In further examples, phyllosilicate nanoparticles can be treated by thermal treatment, hydration, oxidation, acid treatment, base treatment, or combinations thereof. In some examples, thermal treatment can include heating the phyllosilicate nanoparticles to a temperature from about 100° C. to about 1,000° C., or from about 100° C. to about 800° C., or from about 100° C. to about 600° C., or from about 100° C. to about 400° C., or from about 400° C. to about 1,000° C., or from about 400° C. to about 800° C., or from about 400° C. to about 600° C., or from about 600° C. to about 1,000° C. In further examples, acid or base treatment can include adding an acid or base to the phyllosilicate nanoparticles. The acid or base can include NaOH, KOH, HCl, H₂SO₄, HNO₃, or other acids or bases.

In some examples, a weight ratio of the raw phyllosilicate particles to modifying groups that may be added to the phyllosilicate particles can be from about 1,000:1 to about 10:1, or from about 1.000:1 to about 50:1, or from about 1,000:1 to about 100:1, or from about 1,000:1 to about 500:1, or from about 500:1 to about 10:1, or from about 500:1 to about 50:1, or from about 500:1 to about 100:1, or from about 10:1 to about 10:1, or from about 100:1 to about 50:1.

Non-limiting examples of phyllosilicates that can be used in the composite solid electrolyte can include kaolinite, halloysite, chrysotile, antigorite, talc, pyrophyllite, montmorillonite, chlorite, mica, sepiolite, serpentine, and others.

Composite solid electrolytes according to the present technology can be formed to have advantageous properties for use in solid-state batteries. For example, the composite solid electrolyte can have good ionic conductivity, lithium ion transference number, weight, chemical stability, thermal stability, mechanical stability, and flexibility. The properties can be influenced by the composition of the composite solid electrolyte. The type of polymer, lithium salt, and bilayer phyllosilicate used can affect the properties of the resulting electrolyte. The relative amounts of these components can also affect the properties.

In certain examples, the composite solid electrolyte can include from 1 wt % to 30 wt % bilayer phyllosilicate nanoparticles. In more specific examples, the composite solid electrolyte can include from 0.5 wt % to 30 wt % bilayer phyllosilicate nanoparticles. In further examples, the amount of bilayer phyllosilicate nanoparticles can be from 5 wt % to 15 wt % or from 5 wt % to 10 wt % or from 10 wt % to 30 wt % or from 20 wt % to 30 wt %. The ratio of polymer to lithium salt can also affect the properties of the electrolyte. For polyether polymers, the molar ratio of monomer units to lithium ions can be calculated. For example, if the polymer is polyethylene oxide, then the molar ratio of ethylene oxide (EO) units to lithium ions from the lithium salt can be calculated. In some examples, this EO:Li ratio can be from 8:1 to 25:1. In more specific examples, the EO:Li ratio can be from 10:1 to 20:1. For other polymers, a ratio of monomer units to lithium ions can be in the same ranges.

The ratio of lithium salt to phyllosilicate nanoparticles can also affect the properties of the electrolyte. In some examples, a weight ration of lithium salt to phyllosilicate nanoparticles can be from about 2:1 to about 5:1. In certain examples, the lithium salt can be LiTFSI and the phyllosilicate nanoparticles can be halloysite nanotubes.

In various examples, the composite solid electrolyte can comprise the solid polymer, lithium salt, and bilayer phyllosilicate nanoparticles as well as additional additives. In some examples, the composite solid electrolyte can consist of or consist essentially of the solid polymer, lithium salt, and bilayer phyllosilicate nanoparticles.

In a particular example, the bilayer phyllosilicate nanoparticles can be halloysite nanotubes, the polymer can be polyethylene oxide, and the lithium salt can be LiTFSI. The amount of halloysite nanotubes in the composite solid electrolyte can be about 10 wt %. The remainder of the composite solid electrolyte can consist of polyethylene oxide and LiTFSI. The molar ratio EO:Li in this example can be about 15:1.

In other examples, the ionic conductivity of the composite solid electrolyte can be affected by using phyllosilicate nanotubes grafted with short chain functional groups. The functional groups can bind with the inside atoms of the nanotube and occupy the volume within the nanotubes, providing a high ionic conductivity pathway for ions within the nanotubes. The short chain functional group can be carbonate, ethylene oxide, and phosphazene, although other groups can be suitable.

As mentioned above, the composite solid electrolyte can be formed to have useful properties for use in lithium batteries. In some examples, the composite solid electrolyte can have a sufficient ionic conductivity across a range of temperatures, including room temperature, to be useful in lithium batteries. In some examples, the composite solid electrolyte can have an ionic conductivity of greater than 10⁻⁴ S cm⁻¹ at 25° C. In certain examples, the composite solid electrolyte can have an ionic conductivity of greater than 5×10⁻⁴ S cm⁻¹ at 25° C., or even greater than 10⁻³ S cm⁻¹ at 25° C. The ionic conductivity can also increase with increasing temperature. In a further example, the composite solid electrolyte can have an ionic conductivity of greater than 10⁻³ S cm⁻¹ at 60° C.

The composite solid electrolytes according to the present technology can also have a suitable lithium ion transference number (t⁺). In some examples, the lithium ion transference number can be from 0.3 to 0.5. This can compare favorably to a pure PEO electrolyte, which can have a lithium ion transference number from about 0.1 to about 0.25.

Electrochemical stability of the composite solid electrolyte can be characterized by the decomposition voltage, or the highest voltage that can be applied to the electrolyte before the electrolyte chemically decomposes at a particular temperature. In some examples, the composite solid electrolyte can have a decomposition voltage from 5 V to 7 V at 25° C. In further examples, the composite solid electrolyte can have a decomposition voltage from 4.5 V to 6 V at 100° C. The decomposition voltage of the composite solid electrolyte can compare favorably to commercially available liquid organic electrolytes, many of which decompose at around 4.2 V.

The present technology also extends to methods of making composite solid electrolytes. One example method can include: dispersing bilayer phyllosilicate nanoparticles in a solvent; dissolving a solid polymer in the solvent; adding a plasticizer to the polymer in the solvent; dissolving a lithium salt in the solvent; and removing the solvent to form the composite solid electrolyte. In some non-limiting examples, the solvent can include acetonitrile, acetone, alcohol. N-methyl-2-pyrrolidone, tetrahydrofuran, pyridine, dimethyl sulfoxide and water. In a particular example, the solvent can be acetonitrile.

The amounts of solvent, bilayer phyllosilicate nanoparticles, lithium salt, polymer, and plasticizer mixed in this process can generally be any amounts sufficient to form a composite solid electrolyte having the desired properties. In some examples, the concentration of solids (including the phyllosilicate nanoparticles, lithium salt, and polymer) dispersed or dissolved in the solvent can be from 0.1 mg/mL to 20 mg/mL. In further examples, the concentration of solids can be from 1 mg/mL to 10 mg/mL.

The solid components can be mixed with the solvent by any suitable mixing method for a sufficient time to form a homogeneous dispersion. In one example, the solid components can be added to the solvent and the mixture can be stirred for 1 to 5 hours. In a particular example, the bilayer phyllosilicate nanoparticles can be added to the solvent first, and then stirred for 30 minutes to 1 hour. The lithium salt, polymer, and plasticizer can then be added, and the mixture can be stirred for an additional 1 to 4 hours.

The dispersion of solid components in the solvent can be dried to form the composite solid electrolyte. In various examples, the dispersion can be molded, formed into sheets, coated on substrates, or otherwise shaped and then allowed to dry. In one example, a quantity of the dispersion can be dropped onto a flat surface and allowed to dry, forming a dried composite solid electrolyte layer. The dried layer can then be peeled off and used in a battery. Layers and sheets of the composite solid electrolyte can be cut, shaped, folded, bent, curved, and so on as convenient for forming a lithium battery electrolyte. In some examples, a composite solid electrolyte layer can be formed with the same dimensions as an anode and cathode for a battery, and then the electrolyte layer can be pressed between the anode and cathode to form a battery cell.

The composite solid electrolyte can be formed as a film in some examples. In certain examples, the composite solid electrolyte can be a thin film with a thickness from about 1 μm to about 300 μm. In further examples, the film can have a thickness from about 1 μm to about 100 μm, or from about 1 μm to about 50 μm, or from about 10 μm to about 300 μm, or from about 10 μm to about 100 μm, or from about 10 μm to about 50 μm, or from about 50 μm to about 100 μm.

The present technology also encompasses solid-state lithium battery cells employing the composite solid electrolytes described above. In one example, a solid-state lithium battery cell can include a composite solid electrolyte layer, an anode in contact with a first surface of the composite solid electrolyte layer, and a cathode in contact with a second surface of the composite solid electrolyte layer. The composite solid electrolyte layer can include a solid polymer, a plasticizer, bilayer phyllosilicate nanoparticles distributed in the solid polymer, and a lithium salt distributed in the solid polymer. The anode can contain lithium.

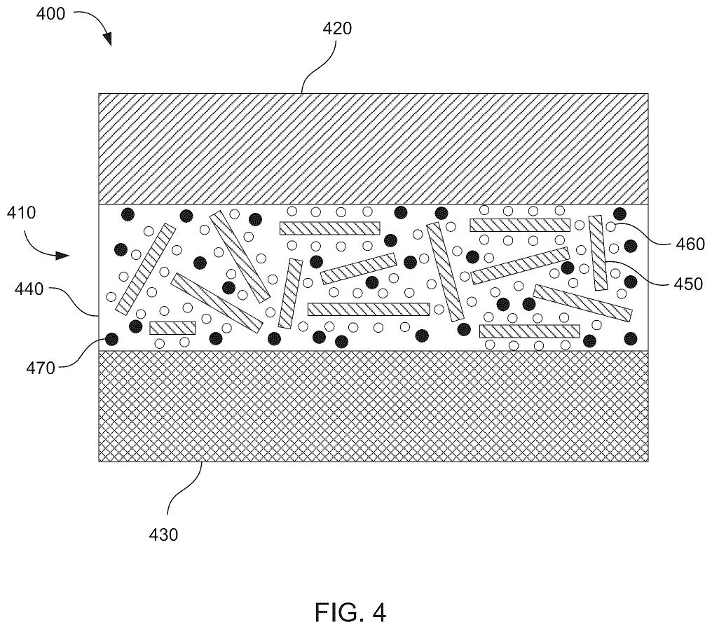

FIG. 4 shows one example of a solid-state lithium battery cell 400 in accordance with the present technology. The battery cell includes a composite solid electrolyte 410 between an anode 420 and a cathode 430. The composite solid electrolyte is made up of a solid polymer 440 having bilayer phyllosilicate nanoparticles 450, lithium ions 460, and plasticizer 470 distributed therein.

In some examples, the anode can include lithium. In certain examples, the anode can consist of or consist essentially of lithium metal. In further examples, the cathode can comprise sulfur. In some examples, the cathode can be a sulfur composite. For example, the cathode can be made of one or more of LiFePO₄, LiCoO₂, LiMnO₄ and Li(NiₓCo_{y}Mn_{z})O₂ while the anode can be formed of one or more of graphite, silicon, and tin. These same principles can also be applied to sodium ion batteries.

Battery cells employing the composite solid electrolytes described herein can have good power density and energy density. In some examples, the energy density, or capacity, of a battery can decrease from an initial value to a lower value after one or more charge/discharge cycles. Typically, charging and discharging at a lower C-rate can preserve a higher capacity. In one example, a battery according to the present technology can have an initial discharge capacity of at least 1200 mAh g⁻¹ and the discharge capacity can decrease to a lower discharge capacity of at least 600 mAh g⁻¹ after 100 cycles at 0.1 C discharge rate at 25° C. When discharged at a higher C-rate, the discharge capacity can decrease more. In one example, a battery can have a reduced capacity of at least 300 mAh g⁻¹ after 400 cycles at 4 C discharge rate and 100° C. Thus, a useful capacity can be maintained even when used at high C-rate and high temperature.

Solid-state lithium batteries according to the present technology can be made to have any suitable form factor. For example, a solid-state lithium battery can be in a metal or plastic hard sided casing, a flexible polymer pouch, a cylindrical battery casing, an integrated battery formed on a microchip or circuit board, and so on. Multiple solid-state lithium battery cells can be combined in series or parallel to provide more voltage and/or capacity.

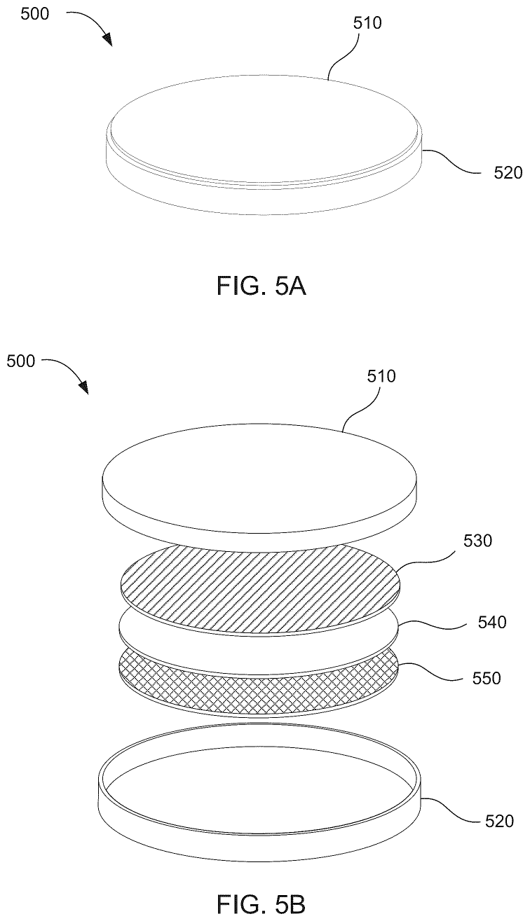

FIGS. 5A and 5B show one example of a solid-state lithium battery 500 having a coin cell form factor. The coin cell has a stainless steel anode casing 510 and a stainless steel cathode casing 520 containing the other battery components. FIG. 5B shows an exploded view, with a lithium anode 530, composite solid electrolyte layer 540, and sulfur-based cathode 550 inside the casing. The casing can substantially enclose the solid-state battery cell sufficient to exclude oxygen from the battery cell. This enclosure can maintain oxygen exclusion for at least an expected product life (i.e. two years, three years, five years, or more depending on the design, environment and expected application).

### EXAMPLES

An example composite solid electrolyte was prepared using a solid polymer matrix, lithium salt, halloysite nanotubes, and two plasticizers. The solid polymer matrix was polyethylene oxide with a molecular weight of 400,000 M_{w}. The lithium salt was LiTFSI. The halloysite nanotubes were modified with potassium tripolyphosphate (referred to as HPKT-HNT). The plasticizers included glutaronitrile (GN) and polyethylene glycol with a molecular weight of 8,000 M. (PEG). These ingredients were dispersed in acetonitrile and then a film was formed and dried. Table 1 shows the amounts of the solid ingredients in the example composite solid electrolyte.

TABLE 1
The SPE composition with HPKT-HNT and double plasticizers.

| Substance | | % |
|---|---|---|
| PEO Molecular weight 400,000 | PEO | 38% |
| Li salt addition | Li Salt | 24% |
| HNT (PEO:HNT = 10:1) | HPKT-HNT | 4% |
| Plasticizer 1 | Glutaronitrile (GN) | 30% |
| Plasticizer 2 | P2 | 4% |
| Solvent | Acetonitrile | |

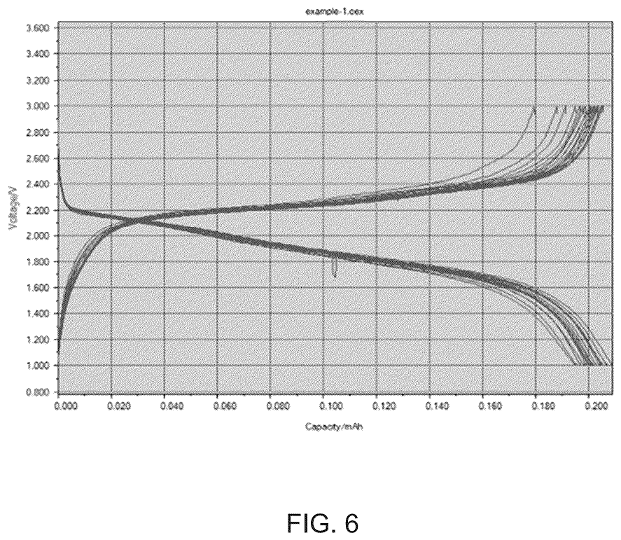

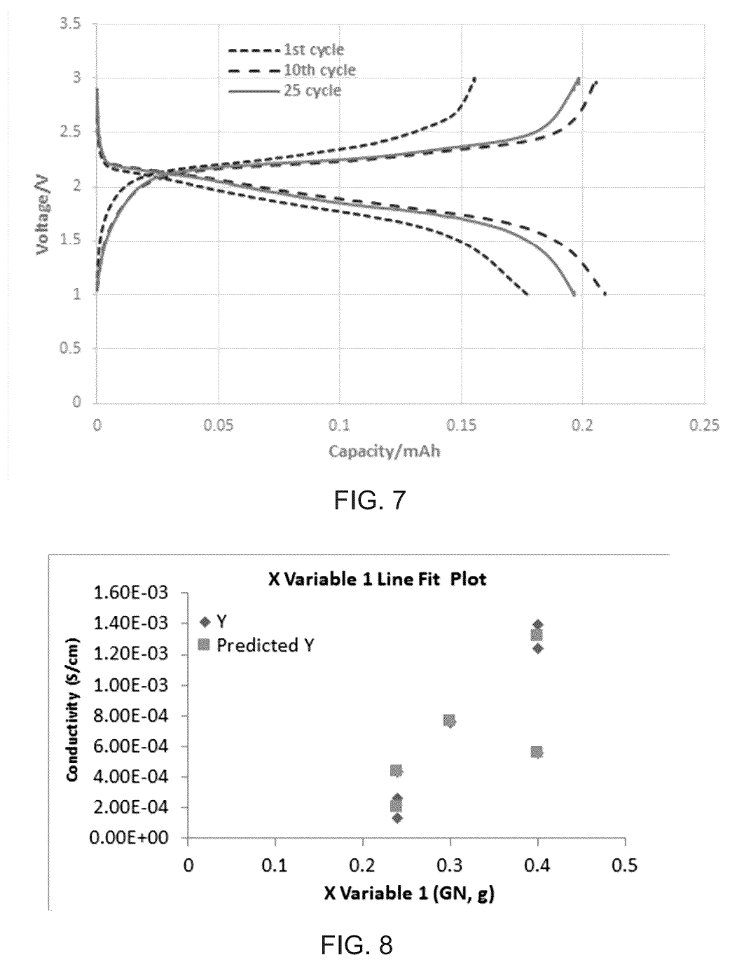

A similar composite solid electrolyte was also prepared without the PEG. Adding the small amount of PEG was found to increase the electrolyte quality and performance. For example, the electrolyte prepared using the formulation shown in Table 1 had an ionic conductivity of 5×10⁻⁴ S cm⁻¹. The film quality and strength were better in the electrolyte including the PEG. Additionally, the cycling stability and capacity were increased. FIG. 6 is a graph of battery cycling voltage (V) vs. capacity (mAh) for a battery using the composite solid electrolyte with the composition of Table 1. The data in FIG. 6 demonstrate good cycling stability and capacity. After 10 cycles the capacity is more than 1000 mAh/g. It is noted that the cycling performance is getting better after several cycles as shown in FIG. 7. This may be due to an increase of interface compatibility.

In order to optimize the combination of two plasticizers in the electrolyte formulation, an experimental design was carried out with two amounts of GN and PEG being added to the electrolyte. The effects investigated by this experiment design are the two plasticizers. GN and PEG, and the interaction of GN and PEG. Table 2 shows the two factors with two levels of addition. The high addition level is represented by 1, and the low addition levels represented by −1. Table 3 shows the 2² design matrix.

TABLE 2
Two factors with two addition levels.

| Factor/Addition | Usage (g) | Code |
|---|---|---|
| GN | 0.240 | −1 |
| | 0.400 | 1 |
| P2 | 0.028 | −1 |
| | 0.048 | 1 |

TABLE 3
2² Design experimental matrix.

| GN (X₁) | PEG (X₂) | GN x PEG (X₃) |
|---|---|---|
| −1 | −1 | 1 |
| −1 | 1 | −1 |
| 1 | −1 | −1 |
| 1 | 1 | 1 |

The following linear regression model was used:

Y=B+C₁X₁+C₂X₂+C₃X₃

Where B is a constant, C, are variables coefficients.

A total of 9 electrolytes were synthesized, including replication testing. The measured conductivity results are presented in Table 4. According to experimental results the following linear equation was obtained by using linear regression:

Conductivity=−0.00165+0.01005 GN+0.0276 PEG−0.16284 GN×PEG

The predicted conductivities using this equation are listed in Table 4. The regression statistics analysis is summarized in Table 5. It can be seen that the regression equation fits the experimental data well.

TABLE 4
Results from the design experiments.

| | | | | Measured | Predicted |
|---|---|---|---|---|---|
| | | | | Conductivity | Conductivity |
| No. | GN (g) | PEG (g) | GN/PEG | S cm⁻¹ | S cm⁻¹ |
| 1 | 0.24 | 0.028 | 0.00672 | 4.40E−04 | 4.36E−04 |
| 2 | 0.24 | 0.048 | 0.01152 | 2.67E−04 | 2.02E−04 |
| 3 | 0.4 | 0.028 | 0.0112 | 1.39E−03 | 1.32E−03 |
| 4 | 0.4 | 0.048 | 0.0192 | 5.60E−04 | 5.60E−04 |
| 5 | 0.24 | 0.028 | 0.00672 | 4.40E−04 | 4.36E−04 |
| 6 | 0.24 | 0.048 | 0.01152 | 1.37E−04 | 2.02E−04 |
| 7 | 0.4 | 0.028 | 0.0112 | 1.24E−03 | 1.32E−03 |
| 8 | 0.3 | 0.028 | 0.0084 | 7.62E−04 | 7.66E−04 |
| 9 | 0.3 | 0.028 | 0.0084 | 7.58E−04 | 7.66E−04 |

TABLE 5
Regression results.

| | | Standard | | |
|---|---|---|---|---|
| | Coefficients | Error | t Stat | P-value |
| Intercept (B) | −0.00165 | 0.00037 | −4.50136 | 0.00639 |
| C1 | 0.01005 | 0.00116 | 8.63132 | 0.00034 |
| C2 | 0.02736 | 0.00970 | 2.82185 | 0.03703 |
| C3 | −0.16284 | 0.03130 | −5.20282 | 0.00346 |

TABLE 6
Regression statistics summary.

| Regression Statistics | |
|---|---|
| Multiple R | 0.99290 |
| R Square | 0.98586 |
| Adjusted R Square | 0,97737 |
| Standard Error | 0.00006 |
| Observations | 9.00000 |

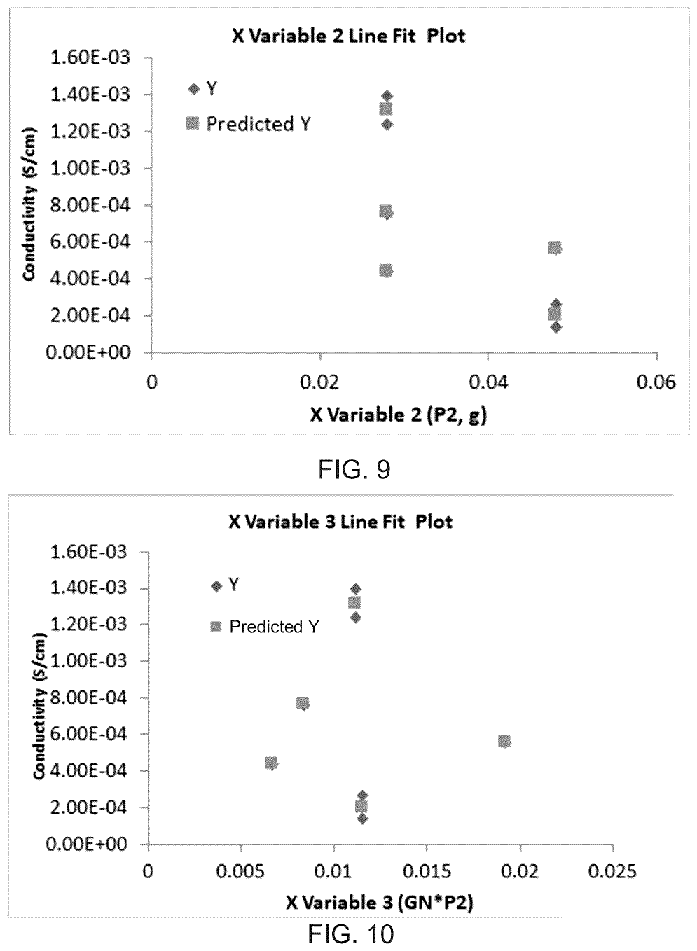

The variable line fit plots are shown in FIGS. 8-10. The PEG is referred to as “P2” in these figures. It can be seen that GN addition significantly increases the lithium ionic conductivity but at 1×10⁻³ S cm⁻¹ the film mechanical properties become weak. The PEG seems to improve the film quality and performance but reduces the conductivity. By combination of two plasticizers the electrolyte had both improved conductivity and performance. These results show that GN and PEG have a synergistic effect of increasing ionic conductivity, cycling performance, and energy capacity more than either of these plasticizers used alone.

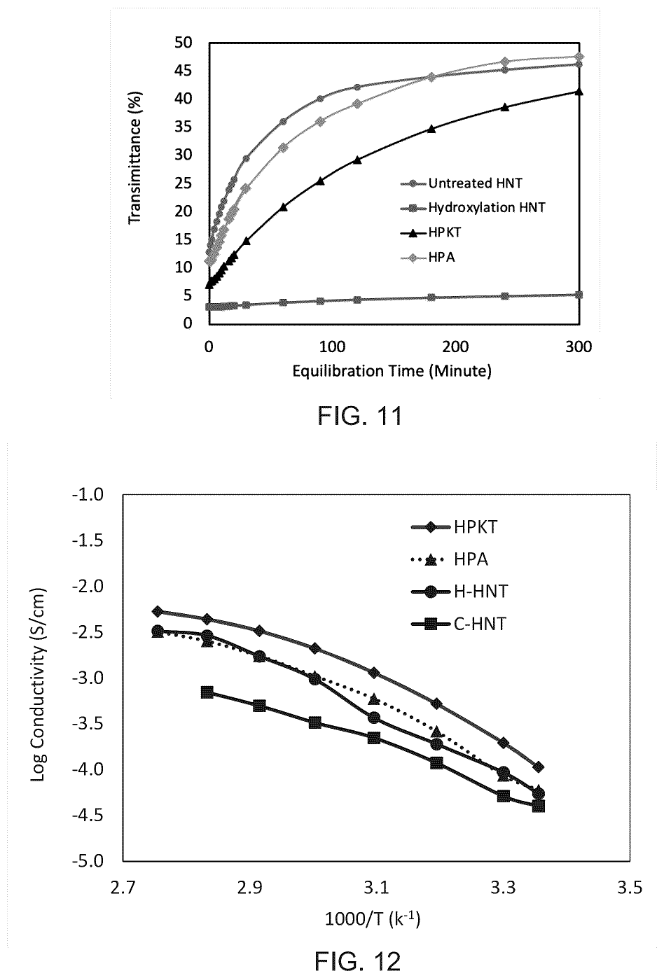

Modifying halloysite nanotubes with other modifying groups was also investigated. Halloysite nanotubes were treated with one of three different modifying groups: potassium tripolyphosphate, ammonia, and hydroxyls. The dispersibility of these treated halloysite nanotubes was tested by mixing the nanotubes with water and measuring the transmittance of the dispersion. FIG. 11 shows the transmittance of the dispersions over time (minutes) for the halloysite nanotubes treated with hydroxyls, potassium tripolyphosphate (HPKT), ammonia (HPA), and raw, untreated halloysite nanotubes. Without being bound to a specific mechanism, it is believed that the potassium tripolyphosphate can adsorb to the surfaces of the halloysite nanotube to change the net surface charge of the halloysite nanotubes, and this can promote repulsive forces between halloysite nanotubes in water.

Composite solid electrolyte films were then prepared that included raw halloysite nanotubes, nanotubes treated with potassium tripolyphosphate, nanotubes treated with ammonia, or nanotubes treated with hydroxyls. The conductivity of the electrolyte was tested at different temperatures. FIG. 12 is a graph of Log Conductivity (S cm⁻¹) vs. 1000/T (K). The nanotubes treated with potassium tripolyphosphate are referred to as “HPKT,” the nanotubes treated with ammonia are “HPA,” the nanotubes treated with hydroxyls are “H-HNT,” and the raw nanotubes are “C-HNT.” As shown in the FIG. the potassium tripolyphosphate increased the conductivity of the electrolyte more than the other modifying groups, but all modifying groups increased conductivity compared to the raw nanotubes.

Electrochemical impedance spectroscopy (EIS) was used in order to gain a better understanding of why the batteries assembled with films containing PEG performed well despite a lower ionic conductivity. Potentiostatic EIS was performed on various samples in the frequency range of 1 Hz-300 kHz. The Nyquist plots for each sample were fitted with an R-RC-W circuit and the electrolyte resistance (R_{S}) as well as charge transfer resistances (R_{CT}) obtained are shown in Table 7. The neat SPE with no HPKT or plasticizers had the highest resistances, as expected. When HPKT was added, both the electrolyte resistance and charge transfer resistances decreased. With addition of GN16 to the HPKT/SPE, the electrolyte resistance decreased by approximately 50% but the charge transfer resistance remained the same. The addition of PEG03 revealed a 260.4Ω decrease in charge transfer resistance indicating a more stable interface between the electrolyte and electrode. After adding back HPKT, the final composition exhibited substantially reduced electrolyte and charge transfer resistances.

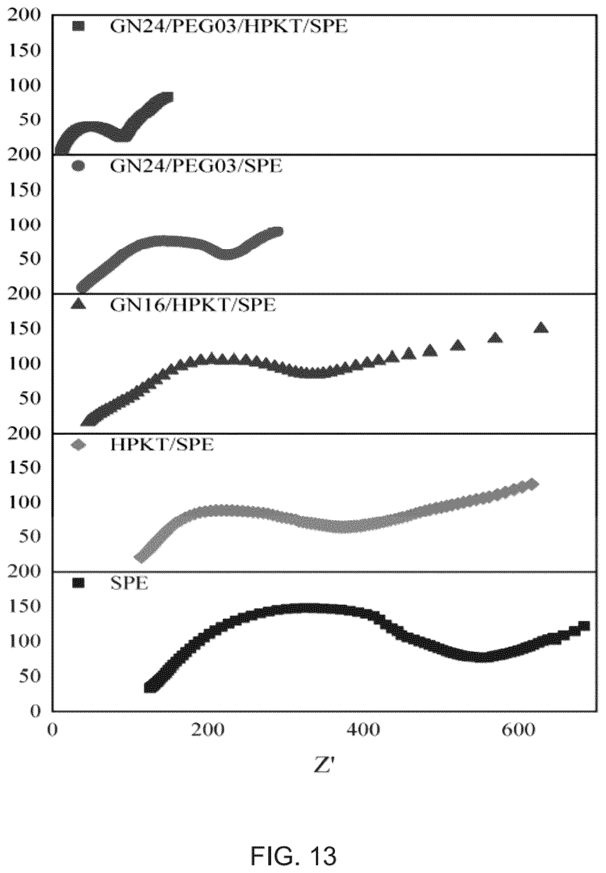

In summary, the EIS study indicated that addition of GN to the HPKT/SPE significantly reduced the electrolyte resistance, as expected, but had no effect on charge transfer resistance. With PEG addition there was a significant drop in charge transfer resistance from 334.4Ω with no PEG to 73.9Ω with PEG. This decrease in charge transfer resistance explains the increased capacity for the PEG/HPKT/SPE battery versus the HPKT/SPE battery and suggests the stabilization of the electrolyte/electrode interface. The Nyquist plots are shown in FIG. 13.

TABLE 7
Summary of electrolyte resistance and charge transfer
resistance from EIS study.

| | | Electrolyte | Charge |
|---|---|---|---|
| | | resistance | transfer |
| | Composition | (Rs) | resistances |
| Electrolyte film | Wt. % | Ω | (R_{CT}) Ω |
| GN24/PEG/ | 30.4% GN, 3.8% PEG, | 10.23 | 73.98 |
| HPKT/SPE | 3.8% HPKT, 24.1%, | | |
| | Li-Salt, 38.0% PEO | | |
| GN24/PEG/SPE | 31.6% GN, 3.9% PEG, | 33.18 | 204.6 |
| | 0% HPKT, 25.0%, Li- | | |
| | Salt, 39.5% PEO | | |
| GN16/HPKT/ | 23.5% GN, 0%PEG, | 45.61 | 334.4 |
| SPE | 4.4% HPKT, 27.9%, | | |
| | Li-Salt, 44.1% PEO | | |
| HPKT/SPE | 0% GN, 0% PEG, | 91.01 | 337.8 |
| | 5.8% HPKT, 36.5%, | | |
| | Li-Salt, 57.7% PEO | | |
| SPE | 0% GN, 0% PEG, 0% | 100.70 | 462.2 |
| | HPKT, 38.8%, Li-Salt, | | |
| | 61.2% PEO | | |

It is to be understood that the above-referenced arrangements are illustrative of the application for the principles of the present invention. Thus, while the present invention has been described above in connection with the exemplary embodiments, it will be apparent to those of ordinary skill in the art that numerous modifications and alternative arrangements can be made without departing from the principles and concepts of the invention as set forth in the claims.

What is claimed is:

1. A composite solid electrolyte for lithium batteries, comprising:
a solid polymer;
phyllosilicate nanoparticles distributed in the solid polymer;
a lithium salt distributed in the solid polymer; and
a plasticizer distributed in the solid polymer.

2. The composite solid electrolyte of claim 1, wherein the solid polymer comprises polyethylene oxide, polymethyl methacrylate, polycarbonate, polysiloxane, starch, sugar, fiber, polyvinyl alcohol, polyphosphazene, polystyrene, or a combination thereof.

3. The composite solid electrolyte of claim 2, wherein the solid polymer comprises polyethylene oxide and wherein a molar ratio of ethylene oxide units to lithium ions (EO:Li) in the composite solid electrolyte is from 8:1 to 25:1.

4. The composite solid electrolyte of claim 1, wherein the composite solid electrolyte is formed as a thin film having a thickness from 1 μm to 300 μm.

5. The composite solid electrolyte of claim 1, wherein the phyllosilicate nanoparticles are in a form of nanotubes, nanoplatelets, or a combination thereof.

6. The composite solid electrolyte of claim 1, wherein the phyllosilicate nanoparticles comprise an aluminum-based phyllosilicate, a magnesium-based phyllosilicate, or a combination thereof.

7. The composite solid electrolyte of claim 1, wherein the phyllosilicate nanoparticles comprise kaolinite, halloysite, chrysotile, antigorite, talc, pyrophyllite, montmorillonite, chlorite, mica, sepiolite, serpentine, or a combination thereof.

8. The composite solid electrolyte of claim 7, wherein the phyllosilicate nanoparticles comprise bilayer halloysite nanotubes.

9. The composite solid electrolyte of claim 1, wherein the phyllosilicate nanoparticles are modified with potassium tripolyphosphate, ammonium polyacrylate, hydroxylation, ammonia, or a combination thereof.

10. The composite solid electrolyte of claim 1, wherein the composite solid electrolyte has a lithium ionic conductivity of at least 10⁻⁴ S cm⁻¹ at 25° C.

11. The composite solid electrolyte of claim 1, wherein the lithium salt is LiTFSI.

12. The composite solid electrolyte of claim 1, wherein the phyllosilicate nanoparticles are present in an amount from 1 wt % to 30 wt % with respect to a total weight of the composite solid electrolyte.

13. The composite solid electrolyte of claim 1, wherein a total amount of plasticizer in the composite solid electrolyte is from 4 wt % to 50 wt % with respect to a total weight of the composite solid electrolyte.

14. The composite solid electrolyte of claim 1, wherein the plasticizer is a polyethylene glycol (PEG), glutaronitrile, or a combination thereof.

15. The composite solid electrolyte of claim 14, wherein the PEG has a molecular weight of 200 to 10,000, 200 to 400, or 4000 to 10.000.

16. The composite solid electrolyte of claim 14, wherein the PEG is present in an amount from 2 wt % to 10 wt % and wherein the glutaronitrile is present in an amount from 2 wt % to 40 wt % with respect to a total weight of the composite solid electrolyte.

17. The composite solid electrolyte of claim 16, wherein a weight ratio of PEG to glutaronitrile is from 1:20 to 1:4.

18. A solid-state lithium battery cell, comprising:
a composite solid electrolyte layer comprising:
a solid polymer,
phyllosilicate nanoparticles distributed in the solid polymer,
a lithium salt or sodium salt distributed in the solid polymer, and
a plasticizer distributed in the solid polymer;
an anode containing lithium in contact with a first surface of the composite solid electrolyte layer;
a cathode in contact with a second surface of the composite solid electrolyte layer; and
a casing that encloses the solid-state battery cell and excludes oxygen from the solid-state battery cell.

19. The solid-state battery cell of claim 18, wherein the cathode comprises sulfur and the anode consists of lithium metal.

20. The solid-state battery cell of claim 18, wherein the solid polymer comprises polyethylene oxide and the phyllosilicate nanoparticles comprise halloysite nanotubes.

21. The solid-state battery cell of claim 18, wherein the phyllosilicate nanoparticles are modified with potassium tripolyphosphate, ammonium polyacrylate, hydroxylation, ammonia, or a combination thereof.

22. The solid-state battery cell of claim 18, wherein the plasticizer is a polyethylene glycol (PEG), glutaronitrile, or a combination thereof.

23. The solid-state battery cell of claim 22, wherein the PEG has a molecular weight of 200 to 10,000, 200 to 400, or 4000 to 10,000.

24. The solid-state battery cell of claim 22, wherein the PEG is present in an amount from 2 wt % to 10 wt % and wherein the glutaronitrile is present in an amount from 2 wt % to 40 wt % with respect to a total weight of the composite solid electrolyte.

25. The solid-state battery cell of claim 23, wherein a weight ratio of PEG to glutaronitrile is from 1:20 to 1:4.
